(19) United States
(12) Patent Application Publication
(10) Pub. No.: US 2008/0212968 A1
(43) Pub. Date: Sep. 4, 2008

(54) Photonic Link With Improved Dynamic Range

(75) Inventors: Richard Lindop, Edinburgh (AU); Kamal Gupta, Edinburgh (AU); Tony Lindsay, Edinburgh (AU); Roger Nicks, Edinburgh (AU); David Palumbo, Edinburgh (AU); Alex Vanderklugt, Edinburgh (AU); Timothy Priest, Edinburgh (AU)

Correspondence Address: MCDERMOTT WILL & EMERY LLP, 18191 VON KARMAN AVE., SUITE 500, IRVINE, CA, 92612-7108, US

(73) Assignee: THE COMMONWEALTH OF AUSTRALIA, Edinburgh (AU)

(21) Appl. No.: 11/916,431

(22) PCT Filed: Jun. 5, 2006
(86) PCT No.: PCT/AU2006/000758

§ 371 Date: Feb. 29, 2008

(30) Foreign Application Priority Data
Jun. 3, 2005 (AU) 2005902948

(51) Int. Cl. H04J 14/02

(52) U.S. Cl. 398/91

(57) ABSTRACT

A photonic link system for transmitting and receiving an optical signal in accordance with an input signal is disclosed. The system includes a photonic transmitter and a photonic receiver. The photonic transmitter includes a first signal path including a first photonic modulator for producing a first output optical signal modulated by the input signal and a second signal path in parallel with the first path photonic path where the second signal path also includes a second modulator for producing a second output optical signal modulated by the input signal. The relative gain of the first and second signal paths is different to provide first and second output optical signals of different relative gain. The photonic receiver includes a first input to receive the first output optical signal from the photonic transmitter and a second input to receive the second output optical signal from the photonic transmitter. The photonic receiver further includes a switch for selectively switching between the first and second inputs in accordance with a measure of magnitude of one or both of the first and second input optical signals.

### RELATED APPLICATIONS

The present application claims priority from Australian Provisional Patent Application No. 2005902948, filed 3 Jun. 2005, entitled “Photonic Link with Improved Dynamic Range,” which is hereby incorporated by reference herein in its entirety.

### FIELD OF THE INVENTION

The present invention relates to photonic systems. In a particular form, the present invention relates to improving the dynamic range of a photonic link.

### BACKGROUND OF THE INVENTION

Photonics technologies have gathered momentum for use in military applications over the last several years, as they offer a range of potential advantages including, weight and volume reductions, reduced power requirements, electromagnetic interference (EMI), electromagnetic countermeasures (EMC) and emission security (EMSEC) benefits and redundancy capabilities. However, one area of system performance in which photonics technologies have been perceived as being unable to match traditional radio frequency (RF) links is their comparatively reduced dynamic range.

Since the earliest implementations of externally modulated RF photonic links, the improvement of dynamic range of these devices has been an area of major focus.

One approach has focused on the reduction of the inherent noise in the photonic links by either employing external modulators or by utilising high optical power in combination with balanced detection. However, these approaches do not address the fundamental problem that ultimately limits the linearity of these systems which is the non-linear (i.e. raised cosine) nature of the Mach-Zehnder Modulator (MZM) transfer function under large signal conditions.

Methods of increasing the dynamic range based on increasing the RF attenuation before or after the modulator have been suggested as have methods utilising optical attenuators. However, whilst these methods allow for the adjustment of the window of RF power over which the system can be operated, they all suffer from the significant disadvantage that they do not increase the instantaneous dynamic range of the photonic link as the noise floor is also raised by the noise introduced by the attenuator by a corresponding amount. These techniques also suffer from the switching speed required to change the optical or RF attenuation which can cause incoming pulsed signals to be distorted or missed altogether.

Another approach designed to increase the dynamic range of a photonic link is based on the suppression of inter-modulation and harmonic content. However, these methods suffer from being intrinsically narrow-band in that optimising for one optical wavelength will not optimise for another wavelength. Accordingly, these techniques offer only limited increases to dynamic range, since typically only some of the inter-modulation products and/or harmonics can be suppressed at any given time.

It is an object of the present invention to provide a method and system for increasing the dynamic range of a photonic link.

### SUMMARY OF THE INVENTION

In a first aspect the present invention accordingly provides a photonic transmitter for transmitting an optical signal to a photonic receiver in accordance with an input signal, the photonic transmitter including:
a first signal path including a first photonic modulator for producing a first output optical signal modulated by the input signal;
a second signal path in parallel with the first signal path, the second signal path including a second modulator for producing a second output optical signal modulated by the input signal, wherein the relative gain of the first and second signal paths is different to provide first and second output optical signals having a relative gain difference.

Preferably, the second modulator for producing the second output optical signal has a different gain when compared to the input signal that forms an input to the second modulator.

Preferably, the relative gain of the first and second modulators is different.

Preferably, the input signal is an electromagnetic signal.

Preferably, the electromagnetic signal is an RF signal.

Preferably, the first and second output optical signals are transmitted over respective fibres.

Optionally, the first and second output optical signals are combined by a photonic signal combiner to provide a combined optical signal.

Preferably, the photonic signal combiner is a multiplexer.

Preferably, the multiplexer is a wavelength division multiplexer.

In a second aspect the present invention accordingly provides a photonic receiver for receiving an optical signal, wherein the photonic receiver includes a first input to receive a first input optical signal and a second input to receive a second input optical signal of different relative gain, the photonic receiver including a switch for selectively switching between the first and second inputs in accordance with a measure of magnitude of one or both of the first and second input optical signals.

Preferably, the measure of magnitude is determined by applying a predetermined threshold to one or both of the first and second input optical signals.

Preferably, the photonic receiver includes a converter to convert a switched optical signal output from the switch to an electromagnetic signal.

Preferably, the electromagnetic signal is an RF signal.

Preferably, the photonic receiver includes a first converter to convert the first input optical signal to a first electromagnetic signal and wherein the photonic receiver includes a second converter to convert the second input optical signal to a second electromagnetic signal and wherein the switch selectively switches between the first and second electromagnetic signals in accordance with a measure of magnitude of one or both of the first and second electromagnetic signals.

Preferably, the measure of magnitude between the first and second electromagnetic signals is determined by applying a predetermined threshold to one or both of the first and second electromagnetic signals.

Preferably, the first and second electromagnetic signals are RF signals.

Preferably, the photonic receiver further includes a delay stage to delay the first and second input optical signals prior to the switch.

Preferably, the first and second input optical signals are combined and the photonic receiver includes a single input incorporating a decombiner to decombine the first and second input optical signals.

Preferably, the decombiner is a demultiplexer.

Preferably, the demultiplexer is a wavelength division demultiplexer. In a third aspect the present invention accordingly provides a photonic link system for transmitting and receiving an optical signal in accordance with an input signal, the system including a photonic transmitter and a photonic receiver, wherein the photonic transmitter includes:
a first signal path including a first photonic modulator for producing a first output optical signal modulated by the input signal;
a second signal path in parallel with the first path photonic path, the second signal path including a second modulator for producing a second output optical signal modulated by the input signal, wherein the relative gain of the first and second signal paths is different to provide first and second output optical signals of different relative gain, and wherein the photonic receiver includes:
a first input to receive the first output optical signal from the photonic transmitter;
and a second input to receive the second output optical signal from the photonic transmitter, the photonic receiver including a switch for selectively switching between the first and second inputs in accordance with a measure of magnitude of one or both of the first and second input optical signals.

In a fourth aspect the present invention accordingly provides a method for increasing the dynamic range of a photonic link between a photonic transmitter and a photonic receiver, the method including:
at the photonic transmitter:
in a first signal path producing a first output optical signal modulated by an input signal;
in a second signal path in parallel with and having a different gain to the first signal path, producing a second output optical signal with the input signal; and
transmitting the first output optical signal and the second output optical signal; and at the photonic receiver:
selectively switching between the first output optical signal and the second output optical signal in accordance with a measure of magnitude of one or both of the first and second output optical signals.

In a fifth aspect the present method accordingly provides a method for transmitting an optical signal in accordance with an input signal to a photonic receiver, the method including:
in a first signal path producing a first output optical signal modulated by the input signal;
in a second signal path in parallel with and having a different gain to the first signal path, producing a second output optical signal with the input signal; and
transmitting the first output optical signal and the second output optical signal.

In a sixth aspect the present invention accordingly provides a method for receiving an optical signal, the method including:
receiving a first input optical signal
receiving a second input optical signal of different relative gain to the first input optical signal; and
selectively switching between the first and second input optical signals in accordance with a measure of magnitude of one or both of the first and second input optical signals.

### BRIEF DESCRIPTION OF THE DRAWINGS

A preferred embodiment of the present invention will be discussed with reference to the accompanying drawings wherein:

FIG. 1 is a system overview of the photonic link system according to a preferred embodiment of the present invention;

FIG. 2 is a system block diagram of the amplified channeliser that forms a component of the antenna module illustrated in FIG. 1;

FIG. 3 is a system block diagram of the modulator and laser source that form components of the antenna module illustrated in FIG. 1;

FIG. 4 is a system block diagram of the receiver module of the photonic link system illustrated in FIG. 1;

FIG. 5 is a circuit schematic for the RF switch that forms a component of the receiver module illustrated in FIG. 4; and

FIG. 6 is a circuit schematic for the decision circuit that forms a component of the receiver module illustrated in FIG. 4.

In the following description, like reference characters designate like or corresponding parts throughout the several views of the drawings.

### DESCRIPTION OF PREFERRED EMBODIMENT

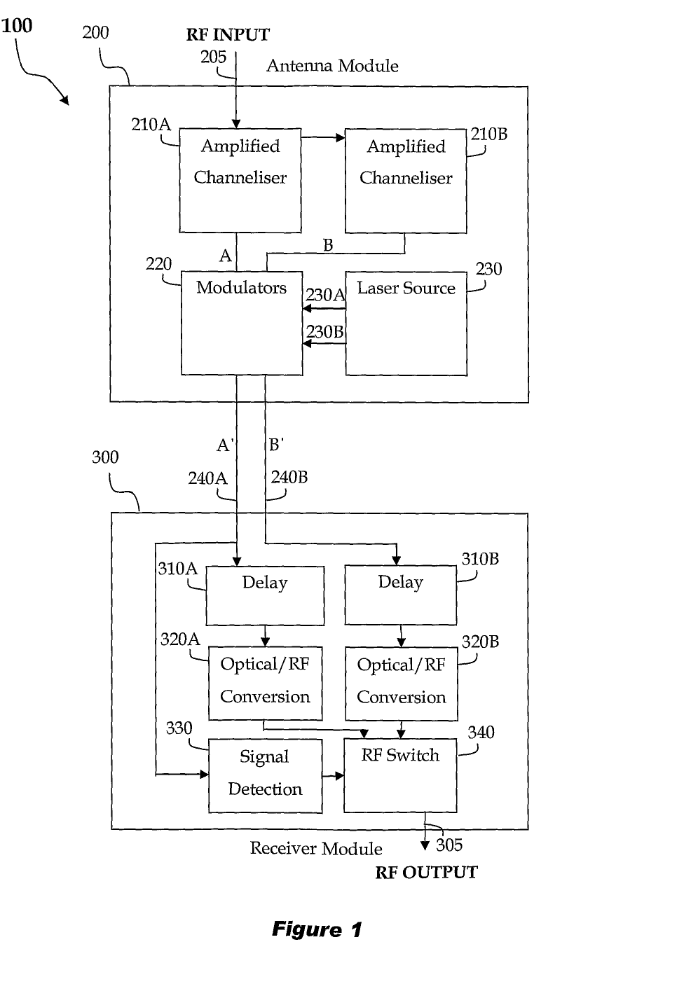

In one aspect of the present invention, dual modulator links are employed in parallel, in conjunction with an appropriate electronic or photonic decision circuitry, to increase the dynamic range of the dual link when compared to that of a single modulator photonic link. Throughout the description the components and signals associated with what will be termed the high sensitivity signal path, link or channel of the dual link will be generally indicated by “A”, whereas the signals and components of the low sensitivity or high power signal path, link or channel will be generally indicated by “B”. Referring now to FIG. 1, there is shown a photonic link system 100 according to a preferred embodiment of the present invention. Photonic link system 100 includes an antenna module 200 configured as a photonic transmitter and a receiver module 300 which functions as a photonic receiver. Linking antenna module 200 and receiver module 300 is a pair of single mode (SM) fibre optic cables 240A and 240B which carry the modulated optical signals A′ and B′ between antenna module 200 and receiver module 300.

Antenna module 200 includes two amplified channelisers 210A and 210B and a corresponding pair of optical modulators 220 which convert the amplified RF signals A and B from each of the amplified channelisers 210A, 210B to associated optical signals A′ and B′. Modulators 220 are driven by laser source 230 which provides dual laser outputs 230A, 230B which in this preferred embodiment are of equal wavelength.

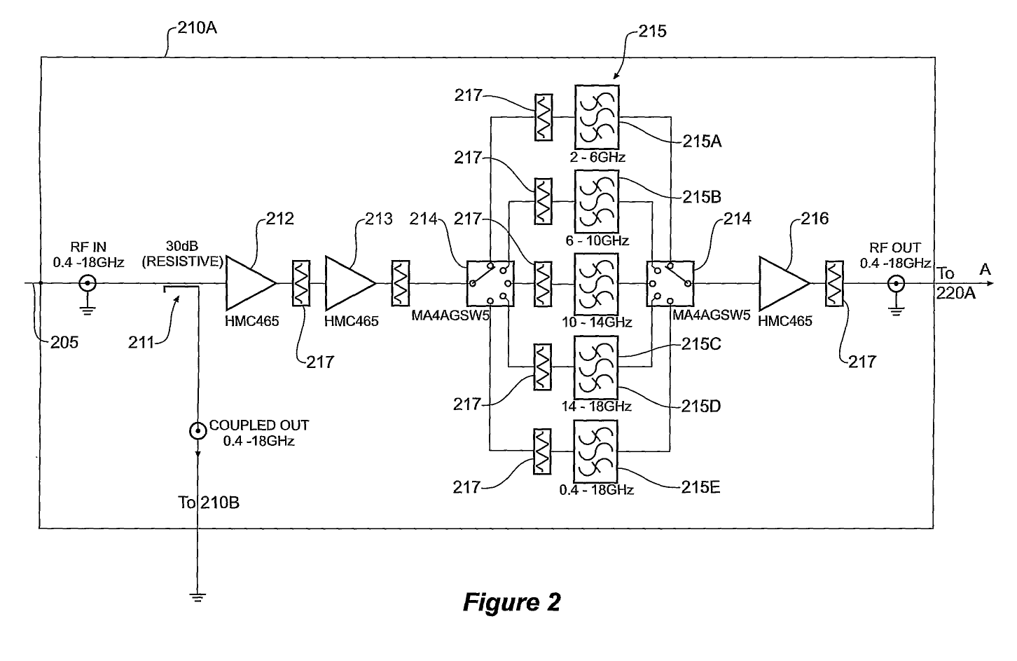

Referring now to FIG. 2, there is shown a detailed view of amplified channeliser 210A. The first stage of amplified channeliser 210A is a 30 dB resistive coupler 211 with the coupled output from channeliser 210A forming the input to second channeliser 210B. As such, the passage of an RF signal through amplified channeliser 210A defines a first signal path of high sensitivity and the passage of the RF signal through amplified channeliser 210B defines a second signal path of low sensitivity or high power. Following the initial resistive coupler 211, is a pair of monolithic microwave integrated circuit (MMIC) RF amplifiers 212, 213 which in this preferred embodiment are Hittite™ HMC465 devices. These components each have performance characteristics of better than 16 dB gain from direct current (DC) to 18 GHz and a noise figure of less than 4 dB from 2 GHz.

The next stage of amplified channeliser 210 is a switched filter 215 which includes a pair of M/A-Com™ MA4AGSW5 switches 214 which function as the input and output switching stages of switch filter 215. As is known in the art, switches 214 are AlGaAs SP5T PIN diode MMIC switches. Switched filter 215 can be used to isolate a desired signal from interference such as continuous wave (CW) radars or jamming devices. The bias for each switch 214 is nominally −10 mA for the ON channel and +10 mA for the OFF channel with a maximum insertion loss of −1.4 dB for the frequency range 50 MHz to 18 GHz under this bias condition. Switch 215 includes a M/A-Com™ DR65-0109 single channel driver (not shown) which can provide a DC output current ranging from ±50 mA, thereby enabling a single chip to drive the same channel on both switches 214.

Switched filter 215 incorporates four sub-band filters 215A, 215B, 215C, 215D and a single all pass path 215E with all pass path 215E extending the amplified channeliser's 210A operation to cover the frequency range of 0.4 GHz to 18 GHz. The other sub-bands that are selectable include 2 GHz to 6 GHz (215A), 6 GHz to 10 GHz (215B), 10 GHz to 14 GHz (215C) and 14 GHz to 18 GHz (215D). As an example, the 2 GHz to 6 GHz filter 215A is designed as the cascade of a 2 GHz high pass filter and a 6 GHz low pass filter with the low pass section implemented in suspended stripline and the high pass section designed as a lumped element filter on microstrip.

As would be appreciated by those skilled in the art, the use of an initial sub-band filter arrangement is not necessarily required for the operation of the present invention, but remains an optional input stage that may be customised according to the operational environment of photonic link system 100.

Following switched filter 215 is a further RF amplifier 216 which in this preferred embodiment is also a Hittite™ HMC465 device. Amplified channeliser 210A also includes a number of passive temperature compensated attenuators 217 which are distributed throughout the channeliser stages to minimise the effect of gain drift from the active components. Amplified channeliser 210A has an input P_{1 dB} compression point of −26 dBm (i.e. the sensitive signal path) with amplified channeliser 210B having an input P_{1 dB} compression point of +11 dBm in the high power signal path.

Whilst in this preferred embodiment, the low sensitivity signal path “B” has been attenuated by an initial 30 dB coupling attenuation, it will of course be understood by those skilled in the art that various combinations of amplification and/or attenuation may be employed to achieve a relative gain difference between the signal paths. For example, the following combinations could be used with respect to the different signal patls “A” and “B”:
(1) amplified high sensitivity signal path and amplified low sensitivity signal path (with appropriate amplifications);
(2) amplified high sensitivity signal path and attenuated low sensitivity signal path;
(3) amplified high sensitivity signal path and unamplified (and unattenuated) low sensitivity signal path;
(4) unamplified high sensitivity signal path and attenuated low sensitivity signal path; and
(5) attenuated high sensitivity signal path and attenuated low sensitivity signal path (with appropriate attenuations).

The choice from the above options will depend on the application for the photonic link system 100 and the area of the input power sensitivity required. It will also be appreciated that a combination of attenuation and amplification can be used to reach an optimum “amplification”. For example, a 40 dB amp in combination with a subsequent 6 dB attenuation may be used in order to obtain 34 dB amplification in the link.

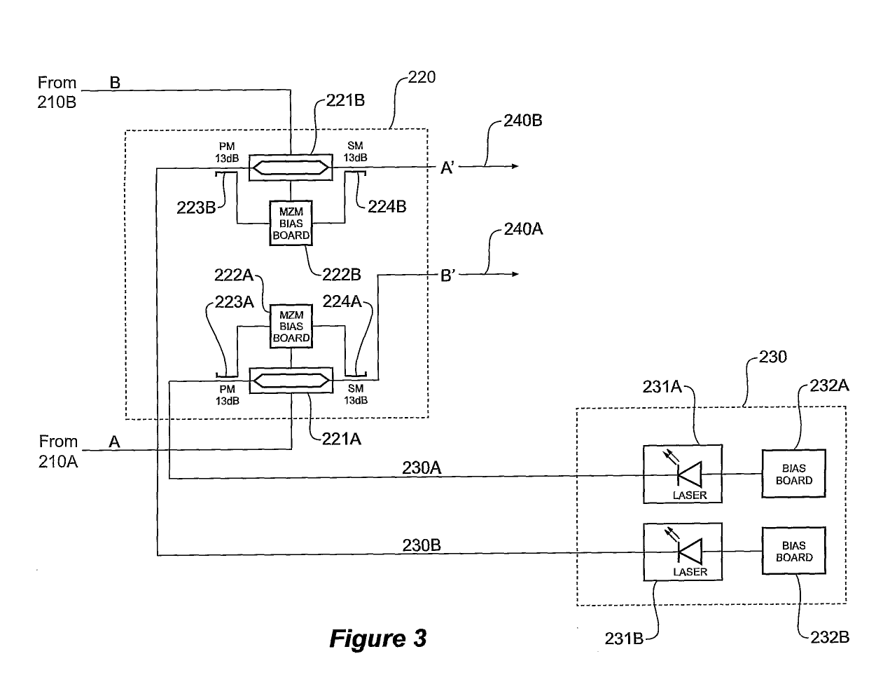

Referring now to FIG. 3, the next stage of antenna module 200 involves the conversion of the RF output signals A, B from amplified channelisers 210A, 210B to respective optical signals A′, B′. This is achieved by modulators 220 driven by laser source 230. As there are two separate RF channels to be processed, a dual channel 20 GHz Mach-Zehnder modulator (MZM) 221A, 221B is employed. In this preferred embodiment, an EOSpace™ optical modulator was utilised (Part No. AX-OK1-20-PFU-PFU). Each channel 221A, 221B is driven by a respective laser 231A, 231B which in this preferred embodiment is a distributed feedback (DFB) laser from Avanex™ (Part No. 3CN 01086AC) having an output wavelength centred at 1550 nm with a maximum optical power of 40 mW. Respective laser controllers 232A, 232B employing analogue circuitry to minimise noise are used to monitor the local temperature and to control the laser bias point of each laser 231A, 231B.

Each channel of optical modulator 221A, 221B incorporates a first polarisation maintaining (PM) optical coupler 223A, 223B on the modulator input and a non-PM coupler 224A, 224B at the modulator output to enable monitoring of output optical signals A′, B′. In this preferred embodiment, both the PM optical coupler 223A, 223B and the non-PM optical couple 224A, 224B are both sourced from AFW Technology™ having part numbers of PMFC-55-1-05-2-L-P-Q and FOSC-1-55-P-2-L-1-F respectively. Each of these couplers has a coupling ratio of 5% and their signals are monitored by MZM controllers 222A, 222B to bias modulators 221A, 221B at the quadrature point to provide low signal distortion. PM components are used between the polarised laser and the modulator input to minimise any polarisation dependent losses. As would be apparent to those skilled in the art, the bias controller can be configured to work independently without an input coupler by employing a modulator transfer characteristic curve. The coupling ratio of input and output couplers or output couplers alone can be of any value.

Whilst in this preferred embodiment optical modulators have been employed, equally other devices functioning to convert an electromagnetic signal to an optical signal are contemplated to be within the scope of the present invention. Some examples of such devices include electroabsorptive (EA) modulators and also direct modulators where the output optical signal is directly modulated by the RF signal. Furthermore, modulators having different attenuation properties may be utilised to enhance the difference in relative gain between each signal path. For example, separate optical modulators having different V_{π} and/or optical losses and/or RF insertion losses may be used in conjunction with, or instead of, RF amplifiers on the different paths to provide the necessary path-gain separation.

In the example of EA modulation, EA modulators with different slope efficiencies can similarly be used in conjunction with, or instead of, RF amplifiers on the different signal paths to also provide the necessary path-gain separation. For modulators using direct modulation, once again lasers with different slope efficiencies can be used in conjunction with, or instead of, RF amplifiers on the different links to provide the necessary path-gain separation in a similar manner.

Although modulators that produce optical signals having different wavelengths are not employed in this preferred embodiment, the use of different optical wavelengths for each signal path and then the use of wavelength division multiplexing (WDM) techniques to transmit the combined modulated signals over a single fibre optic cable with a corresponding de-multiplexing capability in receiver module 300 is also contemplated to be within the scope of the invention. As would also be appreciated by those skilled in the art, laser sources 230 may be located remotely from antenna module 200 with laser input light transferred to modulators by appropriate fibre optic cabling or the like.

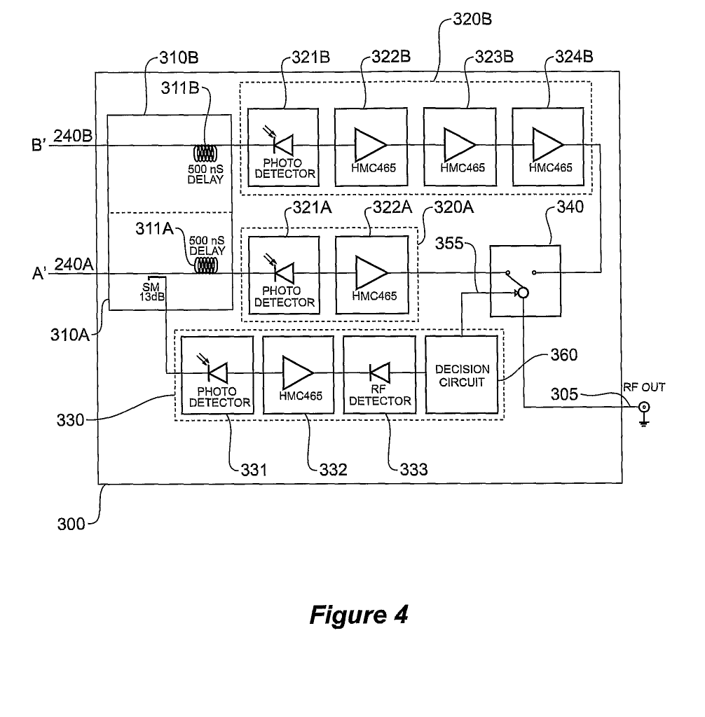

Referring now to FIG. 4, there is shown a system design overview of receiver module 300 according to a preferred embodiment of the present invention. Each modulated output signal A′, B′ from photonic transmitter or antenna module 200 is delayed using a 500 ns fibre loop delay 311A, 311B. Prior to the fibre loop delay 311A on the high sensitivity signal path or channel A, the optical signal A′ is coupled off to signal detection module 330 whose first stage includes a photodetector 331 which in combination with RF amplifier 332 converts the modulated optical signal A′ to an RF signal that then forms an input to RF detector 333 which in this preferred embodiment is an Agilent™ 8474C which incorporates a gallium arsenide, planar-doped barrier detecting element.

The output of RF detector 333 in turn forms an input to decision circuit 360 which, depending on whether the RF signal level detected by RF detector is above a predetermined RF input power level, will switch via switching signal 355 the output of receiver module 300 via RF switch 340 from the default high sensitivity signal path as processed by optical/RF conversion module 320A consisting of photodetector 321A and RF amplifier 322A to the low sensitivity signal path as processed by optical/RF conversion module 320B consisting of photodetector 321B and RF amplifiers 322B, 323B and 324B.

The incorporation of two extra amplification stages 323B, 324B in the low sensitivity (or high power) signal path is designed to provide a compensating gain of 30 dB to the 30 dB of attenuation that occurred at the input to amplified channeliser 210B. In this manner, both the low and high sensitivity channels, links or signal paths are essentially gain matched as the gain on both signal paths is approximately equal and in the RF domain will increase linearly with increasing input power up to the 1 dB compression point of the link. In this preferred embodiment, once again RF amplifiers 322A 322B, 323B and 324B are Hittite™ HMC465 amplifiers.

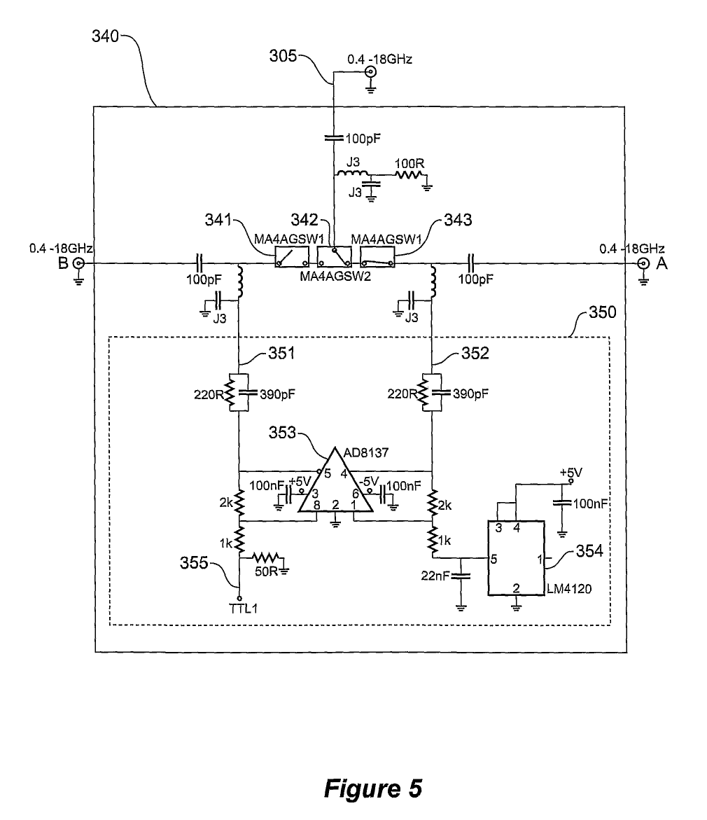

Referring now to FIG. 5, RF switch 340 incorporates both RF switching signal paths “A” & “B” corresponding to the high and low sensitivity paths and associated DC switch driver circuit 350. RF switch 340 consists of two single pole single throw (SPST) FIN diode switches 341, 343 which are located either side of a single pole double throw PIN diode switch 342 all of which are driven by two alternate control signals of ±5 V 351, 352. In this preferred embodiment, SPST PIN diode switches 341, 343 are M/A-COM™ MA4AGSW1 devices and the SPDT diode switch is a M/A-COM™ MA4AGSW2 device. The control signals 351, 352 are produced by DC switch driver circuit 350 which converts transistor-transistor logic (TTL) input switching signal 355 to the complementary differential output signal of ±5 V 351, 352.

DC switch driver circuit 340 performs in a similar manner to a high speed complementary output comparator and incorporates differential driver 353 which in this preferred embodiment is a Analog Devices™ AD8127. Resistors R5 and R7 provide adjustable output voltage swing with C1, R1 and C2, R2 providing tuning to the switching speed. A voltage reference 354 which in this preferred embodiment is a National Semiconductor™ LM4120 provides a reference voltage midrange to TTL input signal 355.

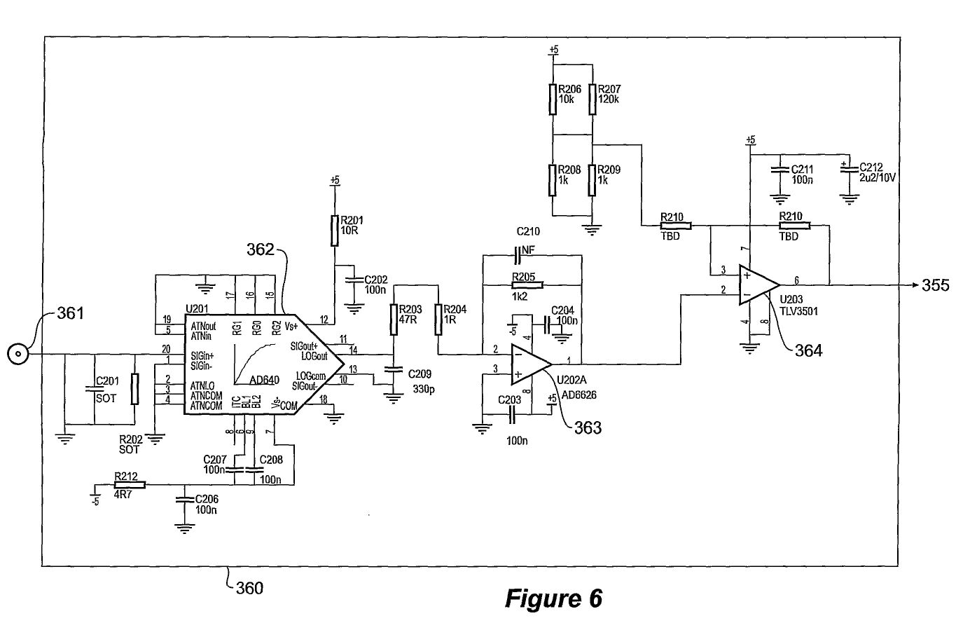

Referring now to FIG. 6, there is shown a detailed breakdown of the decision circuit 360 illustrated in FIG. 4 which generates TTL input switching signal 355 which drives RF switch 340 depicted in detail in FIG. 5. The primary components of decision circuit 360 include an ultra-fast wideband logarithmic amplifier 362, a wide band operational amplifier 363 and a fast switching comparator 364. The video signal output from RF detector 333 forms an input to logarithmic amplifier 362 via a sub-miniature C (SMC) connector 361. In this preferred embodiment, logarithmic amplifier 362 is a Analog Devices™ AD640. The expected voltage input voltage range to logarithmic amplifier 362 varies from approximately 2 mV to 100 mV. Logarithmic amplifier 362 sinks current from the LOGout pin in the range 0.2 mA to 2 mA based on the input voltage range described above.

This current is converted into a voltage by operational amplifier 363. In this preferred embodiment, operational amplifier 363 is based upon an Analog Devices™ AD6626. Once the output voltage from operational amplifier 363 rises above a preset threshold voltage at switcling comparator 364 that corresponds to the high sensitivity signal path limit, the comparator will generate TTL signal 355 to switch RF switch 340 to the low sensitivity signal path. Switching comparator 364, which in this preferred embodiment is a Texas Instruments™ TLV 3501, is configured to have a 1 dB to 7 dB adjustable hysteresis tuning range. The time taken to switch RF switch 340 is approximately 200 ns.

Whilst in this preferred embodiment a relatively simple voltage threshold limit is applied against the high sensitivity signal path to activate RF switch 340, equally another measure of magnitude of one or both signal paths may be employed to switch between the signal paths. Some examples include a threshold limit applied to the low sensitivity signal path or alternatively to a combination of both signal paths. Additionally, more sophisticated signal processing techniques may be employed on the modulated output signals A′, B′ directly or alternatively after conversion to an RF signal by a photodetector or the like which in turn will provide a measure of magnitude of one or both of the signals by detecting changes in the level of these signal.

Whilst in this preferred embodiment, the signals corresponding to the different signal paths are switched electrically, equally the modulated optical signal corresponding to the high sensitivity signal path could be sampled and detected to determine if the optical signal exceeds a predetermined threshold, thereby causing only the modulated optical signal corresponding to the low sensitivity signal path to be converted to an RF signal by virtue of a photodetector instead of the default conversion of the optical signal corresponding to the high sensitivity signal path.

Referring once again to FIGS. 1 to 6, in operation photonic link system 100 will receive an input RF signal 205 to antenna module 200 or photonic transmitter in the 2 GHz to 18 GHz band covered by the link. Input signal 205 then forms the input to the two amplified channelisers 210A, 210B with the input coupled to second channeliser 210B by virtue of a 30 dB coupling arrangement 211, thereby defining a low sensitivity “B” signal path having a higher attenuation (or lower gain) at this initial stage when compared to the normal or high sensitivity “A” signal path. An operator of photonic link system 100 also has the option of selecting a given sub-band by virtue of the sub-band filtering capability of each amplified channeliser 210A, 210B.

The output of both amplified channelisers 210A, 210B is then optically modulated into respective optical signals A′, B′ by modulators 220, with these signals then transported by corresponding SM optical fibres 240A, 240B to photonic receiver or receiver module 300. At the input of receiver module 300, the optical signal from both signal paths undergoes a 500 ns delay. Immediately prior to the delay stages 310A, 310B, the optical signal A′ from the high sensitivity signal path is coupled to photodetector 331 whose resulting RF signal is amplified by RF amplifier 322 and detected by RF detector 333 to provide the input for a signal path selection decision circuit 360.

In normal operation, the high sensitivity signal path will be employed however, when the input RF signal power exceeds a predetermined threshold as determined by path selection decision circuit 360 then RF switch 340 is caused to switch to the low sensitivity signal path. This threshold is set between the points where the intermodulation spurs on the high sensitivity signal path start to appear above the noise floor of the low sensitivity signal path. Accordingly, receiver module 300 will then switch to the low sensitivity or high power signal path thereby preventing saturation of the photonic link.

This switching to the low sensitivity signal path results in a highly accurate high-fidelity reproduction of the high power input waveforms. As would be apparent to those skilled in the art, to maintain high-fidelity between the RF input 205 and the RF output 305 the switching between the low and high sensitivity signal paths “A” and “B” must operate as quickly as possible.

The delay stages 310A, 310B, ensure that the RF switch 340 has time to switch prior to the arrival of the leading edge of a strong signal, thereby preserving the details of the rise time characteristics and initial pulse information from which the majority of advanced signal processing information is derived. This can be especially important in defence applications where the identification of specific emitter identification (SEI) parameters may be critical. Although the switching time for the leading edge of a pulse in the RF input signal will be compensated by the optical delay, the switching time on the trailing edge will not be compensated for by this delay. However, as would be appreciated by those skilled in the art, precise waveform information may not be required in a given application and in these circumstances the present invention may be implemented without a delay stage.

The present invention provides a number of significant advantages over a single path or channel photonic link. As a means of comparison, the performance of a standard single channel modulated link is set out in the following table.

TABLE 1

| Link Parameters | Link Performance (18 GHz bandwidth) |
|---|---|
| laser power = 50 mW | RF link insertion loss = 18 dB |
| modulator V_{π} = 5 V | link noise figure = 33 dB |
| modulator optical loss = 4 dB | Minimal Discernible Signal |
| | (MDS) = −37.5 dBmI |
| excess optical link losses = 1 dB | P_{1dB} (input) = +13.0 dBmI |
| photodetector responsivity = | P_{1dB} (output) = −5 dBmI |
| 0.7 mA/Mw | |
| Photodiode and modulator | Spurious Free Dynamic Range = 39 dB |
| matching coefficients = 0.95 | (referred to MDS) |
| Receiver noise bandwidth = | Compressive Dynamic Range |
| 30 MHz | (CDR) = 50.5 dB (referred to MDS) |

Whilst a CDR of approximately 50.5 dB is generally acceptable for a photonic link that forms part of a warning receiver or is otherwise involved in general electronic support applications, the minimum discernable signal level of −37.5 dBmI is clearly inadequate for these applications. As such, an RF photonic link of this type will nearly always require some form of wideband RF amplifier at the front end to improve sensitivity to a competitive level. However, as discussed previously the inherent limitations to the dynamic range of a single channel photonic link will imply that the link will become easily saturated in the event of a high intensity input signal. In addition, the SFDR of 39 will also be inadequate for a wideband receiver. In this preferred embodiment, the initial amplification stage is provided by amplified channelisers 210A, 210B.

The preferred embodiment of the photonic link system 100 of the present invention as described herein was built and tested with RF output 305 fed into a 30 MHz bandwidth limited M/A Corn Model SMR 3522B superhet receiver. The measured performance characteristics are summarised in the following tables.

TABLE 2

| High Sensitivity Signal Path “A” | Low Sensitivity Signal Path “B” |
|---|---|
| RF link insertion loss = 11.7 dB | RF link insertion loss = −7.3 dB Gain |
| link noise figure = 7.3 dB | link noise figure = 37 dB |
| P_{1dB} (input) = −26 dBm | P_{1dB} (input) = 11 dBm |
| CDR = 67 | CDR = 75 |
| MDS = −93 dBm | MDS = −64 dBm |
| SFDR = 51.5 dB | SFDR = 68.7 dB |
| SFDR = 28.9 dB | SFDR = 24.6 dB (referred to MDS) |
| (referred to MDS) | |

TABLE 3
Photonic Link System Characteristics

Total SFDR = 96 dB (signal detected on appropriate link)
Total CDR = 104 dB (signal detected on appropriate link)

As can be readily appreciated by those skilled in the art, the combined CDR of the links is approximately 104 dB (i.e. the MDS of the high sensitivity signal path to the 1 dB input compression point of low sensitivity signal path) and the SFDR extent of the combined links is in excess of 96 dB.

This overlap region that occurs in the combined CDRs of the two sensitivity signal paths is useful as it mininises the spurious signal content from the more sensitive signal path at the point at which the system would switch between the different path outputs. In this case, the term “spurious” would typically refer to third-order harmonic content of the signal as opposed to third third-order intermods (due to the small probability of “pulse-on-pulse” events). This implies that the incidence of spurious intercepts associated with the harmonic content of the signal will be minimised for a receiver such as a superhet. As would be appreciated by those skilled in the art, an instantaneous frequency measurement (IFM) receiver is essentially insensitive to the harmonic content at the powers under consideration here.

As the overlap region referred to above is large, this enables the lower sensitivity signal path to be switched in well before spurii in the high sensitivity signal path become a problem. Some of the factors that will function to limit the maximum dynamic range of photonic link system 100 will be the overall noise figure of the high sensitivity signal path at the bottom end of the CDR and the 1 dB compression point of the low sensitivity signal path at the top end. As a result of this overlap, a higher gain initial amplification stage may be employed, which will sacrifice the compression point in return for a potentially lower noise figure. This is due to the inherent features of a cascaded or multipath system where a higher gain pre-amplifier will compensate for the high loss and associated noise figure of the subsequent link. This then allows the overall noise figure to approach that of the pre-amplifier itself. The trade off however, is that an amplifier with a high gain will also exhibit higher noise figures so the gain versus the noise figure of the pre-amplifier must be optimised as part of the photonic link design.

As would be appreciated by those skilled in the art, these performance figures set out in TABLE 2 and TABLE 3 are extremely competitive when compared to standard electronic warfare (EW) receiver performance. In the case of wideband receivers such as IFM receivers, it is expected that the dynamic range performance would actually be increased, because the photonic link system 100 of the present invention effectively compresses the signal environment presented to the IFM on a pulse to pulse basis, thereby enabling it to process signals over an operational dynamic range larger than the range for which it was designed.

As such, photonic link system 100 provides enhanced versatility over prior art systems in that any receiver of bandwidth up to that of the photonic link can be fed by the link and maintains an overlap of the spur free portions of the dynamic range. Additionally, as the noise figure of the overall link is dictated by the noise figure of the initial amplification stage and the individual photonic links then this noise figure can be minimised to ensure that the link would not significantly degrade the sensitivity of the receiver it is feeding into. In the preferred embodiment disclosed herein, the top end of the dynamic range is limited to an input power of over 13 dBm which is still higher than the majority of the receivers envisaged to operate in conjunction with the photonic link system 100 as described in the preferred embodiment.

Clearly, the photonic link system 100 of the present invention provides an increased dynamic range over a single channel photonic link. In this preferred embodiment, the increase in dynamic range over a single channel photonic link (around 50 dB) will be increased by approximately 30 dB for the same detecting bandwidth. As would be apparent to those skilled in the art, in contrast to the prior art, the photonic link system of the present invention does not attempt to suppress unwanted signals, but rather selectively discards those signals that have a high non-linear element as a result of link distortion. The technique is therefore intrinsically wide-band and harmonic content independent.

Whilst the present invention has been implemented in the context of a dual-link system, clearly the invention may be implied to include multiple links, channels or paths corresponding to signal paths of different sensitivity in order to improve the dynamic range or granularity of the photonic link or provide a level of redundancy. Additionally, whilst the switching has been employed to switch between a high sensitivity signal path to a low sensitivity signal path equally the default path may be the low sensitivity path where it is expected that high intensity signals would be the norm. Furthermore, whilst in this preferred embodiment the present application has been applied to an RF system, equally the present invention could be applied to other systems where information is transferred by a photonic link and which include input and output signals that come from other parts of the of the electromagnetic spectrum other than the RF such as the infra-red, microwave or the ultra-violet.

Although a preferred embodiment of the method and system of the present invention has been described in the foregoing detailed description, it will be understood that the invention is not limited to the embodiment disclosed, but is capable of numerous rearrangements, modifications and substitutions without departing from the scope of the invention as set forth and defined by the following claims.

1. A photonic transmitter for transmitting an optical signal to a photonic receiver in accordance with an input signal, the photonic transmitter including:
a first signal path including a first photonic modulator for producing a first output optical signal modulated by the input signal;
a second signal path in parallel with the first signal path, the second signal path including a second modulator for producing a second output optical signal modulated by the input signal, wherein the relative gain of the first and second signal paths is different to provide first and second output optical signals having a relative gain difference.

2. The photonic transmitter of claim 1, wherein the input signal that forms an input to the second modulator for producing the second output optical signal has a different gain when compared to the input signal that forms an input to the second modulator.

3. The photonic transmitter of claim 1 or 2, wherein the relative gain of the first and second modulators is different.

4. The photonic transmitter of any one of the previous claims, where the input signal is an electromagnetic signal.

5. The photonic transmitter of claim 4, wherein the electromagnetic signal is an RF signal.

6. The photonic transmitter of any one of the preceding claims, wherein the first and second output optical signals are transmitted over respective fibres.

7. The photonic transmitter of any one of claims 1 to 5, wherein the first and second output optical signals are combined by a photonic signal combiner to provide a combined optical signal.

8. The photonic transmitter of claim 7, wherein the photonic signal combiner is a multiplexer.

9. The photonic transmitter of claim 8, wherein the multiplexer is a wavelength division multiplexer.

10. A photonic receiver for receiving an optical signal, wherein the photonic receiver includes a first input to receive a first input optical signal and a second input to receive a second input optical signal of different relative gain, the photonic receiver including a switch for selectively switching between the first and second inputs in accordance with a measure of magnitude of one or both of the first and second input optical signals.

11. The photonic receiver of claim 10, wherein the measure of magnitude is determined by applying a predetermined threshold to one or both of the first and second input optical signals.

12. The photonic receiver of claim 10 or 11, wherein the photonic receiver includes a converter to convert a switched optical signal output from the switch to an electromagnetic signal.

13. The photonic receiver of claim 12, wherein the electromagnetic signal is an RF signal.

14. The photonic receiver of claim 10, wherein the photonic receiver includes a first converter to convert the first input optical signal to a first electromagnetic signal and wherein the photonic receiver includes a second converter to convert the second input optical signal to a second electromagnetic signal and wherein the switch selectively switches between the first and second electromagnetic signals in accordance with a measure of magnitude of one or both of the first and second electromagnetic signals.

15. The photonic receiver of claim 14, wherein the measure of magnitude between the first and second electromagnetic signals is determined by applying a predetermined threshold to one or both of the first and second electromagnetic signals.

16. The photonic receiver of claim 15, wherein the first and second electromagnetic signals are RF signals.

17. The photonic receiver of any one of claims 10 to 16, wherein the photonic receiver further includes a delay stage to delay the first and second input optical signals prior to the switch.

18. The photonic receiver of any one of claims 10 to 17, wherein the first and second input optical signals are combined and the photonic receiver includes a single input incorporating a decombiner to decombine the first and second input optical signals.

19. The photonic receiver of claim 18, wherein the decombiner is a demultiplexer.

20. The photonic receiver of claim 19, wherein the demultiplexer is a wavelength division demultiplexer.

21. A photonic link system for transmitting and receiving an optical signal in accordance with an input signal, the system including a photonic transmitter and a photonic receiver, wherein the photonic transmitter includes:
a first signal path including a first photonic modulator for producing a first output optical signal modulated by the input signal;
a second signal path in parallel with the first path photonic path, the second signal path including a second modulator for producing a second output optical signal modulated by the input signal, wherein the relative gain of the first and second signal paths is different to provide first and second output optical signals of different relative gain, and wherein the photonic receiver includes:
a first input to receive the first output optical signal from the photonic transmitter;
and a second input to receive the second output optical signal from the photonic transmitter, the photonic receiver including a switch for selectively switching between the first and second inputs in accordance with a measure of magnitude of one or both of the first and second input optical signals.

22. The photonic link system of claim 21, wherein the input signal that forms an input to the second modulator for producing the second output optical signal has a different gain when compared to the input signal that forms an input to the second modulator.

23. The photonic link system of claim 21 or 22, wherein the relative gain of the first and second modulators is different.

24. The photonic link system of any one of claims 21 to 23, wherein the measure of magnitude is determined by applying a predetermined threshold to one or both of the first and second output optical signals.

25. The photonic link system of any one of claims 21 to 24, wherein the photonic receiver includes a converter to convert a switched optical signal output from the switch to an electromagnetic signal.

26. The photonic link system of claim 25, wherein the electromagnetic signal is an RF signal.

27. The photonic link system of any one of claims 21 to 23, wherein the photonic receiver includes a first converter to convert the first output optical signal to a first electromagnetic signal and wherein the photonic receiver includes a second converter to convert the second output optical signal to a second electromagnetic signal and wherein the switch selectively switches between the first and second electromagnetic signals in accordance with a measure of magnitude of one or both of the first and second electromagnetic signals.

28. The photonic link system of claim 27, wherein the measure of magnitude between the first and second electromagnetic signals is determined by applying a predetermined threshold to one or both of the first and second electromagnetic signals.

29. The photonic link system of claim 28, wherein the first and second electromagnetic signals are RF signals.

30. The photonic link system of any one of claims 21 to 29, wherein the photonic receiver further includes a delay stage to delay the first and second output optical signals prior to the switch.

31. The photonic link system of any one of claims 21 to 30, wherein the first and second output optical signals are transmitted over respective fibres to the first and second inputs of the photonic receiver.

32. The photonic link system of any one of claims 21 to 30, wherein the first and second output optical signals are combined by a photonic signal combiner to provide a combined optical signal and wherein the photonic receiver includes a single input incorporating a decombiner to decombine the first and second input optical signals.

33. The photonic link system of claim 32, wherein the combiner is a multiplexer and the decombiner is a demultiplexer.

34. The photonic link system of claim 33, wherein the multiplexer is a wavelength division multiplexer and the demultiplexer is a wavelength division demultiplexer.

35. The photonic link system of any one of claims 21 to 34, wherein the input signal is an electromagnetic signal.

36. The photonic link system of claim 35, wherein the electromagnetic signal is an RF signal.

37. A method for increasing the dynamic range of a photonic link between a photonic transmitter and a photonic receiver, the method including:
at the photonic transmitter:
in a first signal path producing a first output optical signal modulated by an input signal;
in a second signal path in parallel with and having a different gain to the first signal path, producing a second output optical signal with the input signal; and
transmitting the first output optical signal and the second output optical signal; and at the photonic receiver:
selectively switching between the first output optical signal and the second output optical signal in accordance with a measure of magnitude of one or both of the first and second output optical signals.

38. The method as claimed in claim 37 further including:
delaying the first and second output optical signals prior to the step of selectively switching.

39. A method for transmitting an optical signal in accordance with an input signal to a photonic receiver, the method including:
in a first signal path producing a first output optical signal modulated by the input signal;
in a second signal path in parallel with and having a different gain to the first signal path, producing a second output optical signal with the input signal; and
transmitting the first output optical signal and the second output optical signal.

40. A method for receiving an optical signal, the method including:
receiving a first input optical signal
receiving a second input optical signal of different relative gain to the first input optical signal; and
selectively switching between the first and second input optical signals in accordance with a measure of magnitude of one or both of the first and second input optical signals.
